(19) United States
(12) Patent Application Publication
(10) Pub. No.: US 2010/0115036 A1
(43) Pub. Date: May 6, 2010

(54) METHOD, APPARATUS AND COMPUTER PROGRAM PRODUCT FOR GENERATING A COMPOSITE MEDIA FILE

(75) Inventors: Daniela Rosner, San Francisco, CA (US); Manish Anand, Morabadi (IN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA COPORATION, Espoo (FI)

(21) Appl. No.: 12/263,212

(22) Filed: Oct. 31, 2008

(51) Int. Cl. G06F 17/30; G06F 15/16

(52) U.S. Cl. 709/206; 707/E17.108

(57) ABSTRACT

An apparatus for generating a composite media file which may comprise a processor is provided. The processor may be configured to receive an indication of information associated with at least a first media file and submit a search request for information associated with at least a second media file based at least in part on the information associated with the at least first media file. The processor may also be configured to receive the information associated with the at least second media file and generate a composite media file based at least in part on the information associated with the at least one additional media file. The processor may further be configured to provide for display of the composite media file. Associated methods and computer program products may also be provided.

### TECHNOLOGICAL FIELD

Embodiments of the present invention relate generally to communications technology and, more particularly, relate to apparatuses, methods and computer program products for enabling the generation of a composite media file.

### BACKGROUND

The modem communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to and between users and other entities. With the aid of wireless and mobile networking technologies the availability of wireless communications devices has increased, due in part to reductions in cost of devices and the construction of infrastructures able to support these devices. Because consumers can more readily own and/or utilize a wireless communications device, the demands for dynamic functionality of these devices has increased.

The marketplace has responded to these demands by providing increased functionality to the devices. For example, many conventional wireless communications devices now provide for various means of capturing/generating, collecting, modifying, and/or storing large amounts of information (e.g., images, audios, videos, etc.). Many mobile devices also provide access to information sharing via the Internet or other networks. Further, many mobile devices also include location identification capabilities, and other task-specific applications that can be used in conjunction with the communications capabilities of these devices.

One area in which there is a demand to further improve the convenience to users is regarding the effective absorption and/or processing of the large amounts of data captured, stored, and or shared by a user. Accordingly, as mobile devices become more and more ubiquitous, there is a need to create digital information in meaningful or useful ways. Moreover, there is a strong need for integrating data items created on mobile devices, and other devices, with its existing communication functionality.

### BRIEF SUMMARY

A methods, apparatuses and computer program products are therefore provided that may enable generating a composite media file. In this regard, for example, a user may be able to generate a composite media file of one or more user contacts based at least in part on information associated with a reference media file, such as, for example, information relating to at least one user contact represented in the reference media file. The composite media file may be generated with one or more media files that are locally or remotely associated with a user platform or device.

In one example embodiment, a method of generating a composite media file is provided. The method may include receiving an indication of information associated with at least a first media file and submitting a search request for information associated with at least a second media file based at least in part on the information associated with the at least first media file. The method may further include receiving the information associated with the at least second media file and generating a composite media file based at least in part on the information associated with the at least second media file. Additionally, the method may include providing for display of the composite media file.

In another example embodiment, a computer program product for generating a composite media file is provided. The computer program product may include at least one computer-readable storage medium having computer-executable program code portions stored therein. The computer-executable program code portions may include a first program code instructions, second program code instructions, third program code instructions, fourth program code instructions, and fifth program code instructions. The first program code instructions may be for receiving an indication of information associated with at least a first media file. The second program code instructions may be for submitting a search request for information associated with at least a second media file based at least in part on the information associated with the at least first media file. The third program code instructions may be for receiving the information associated with the at least second media file. The fourth program code instructions may be for generating a composite media file based at least in part on the information associated with the at least second media file. The fifth program code instructions may be for providing for display of the composite media file.

In another example embodiment, an apparatus for generating a composite media file is provided. The apparatus may include a processor that may be configured to receive an indication of information associated with at least a first media file and submit a search request for information associated with at least a second media file based at least in part on the information associated with the at least first media file. The processor may further be configured to receive the information associated with the at least second media file and generate a composite media file based at least in part on the information associated with the at least second media file. Additionally, the processor may be configured to provide for display of the composite media file.

In yet another example embodiment an apparatus for generating a composite media file is provided. The apparatus may include means for receiving an indication of information associated with at least a first media file and a means for submitting a search request for information associated with at least a second media file based at least in part on the information associated with the at least first media file. The apparatus may further include means for receiving the information associated with the at least second media file and means for generating a composite media file based at least in part on the information associated with the at least second media file. The apparatus may additionally include means for providing for display of the composite media file.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system according to an example embodiment of the present invention;

FIG. 2 is a schematic block diagram of an apparatus for generating a composite media file according to an example embodiment of the present invention;

FIG. 3A illustrates an example graphical representation according to an example embodiment of the present invention;

FIG. 3B illustrates an example graphical representation based at least in part on the graphical representation of FIG. 3 A according to an example embodiment of the present invention;

FIG. 4 is a schematic block diagram of a system according to an example embodiment of the present invention;

FIG. 5 is a schematic block diagram of a mobile terminal according to an example embodiment of the present invention; and

FIG. 6 is a flowchart according to an example method of generating a composite media file according to an example embodiment of the present invention.

### DETAILED DESCRIPTION

Some of the embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “content item,” “information” and similar terms may be used interchangeably to refer to data capable of being transmitted, received and/or stored in accordance with embodiments of the present invention. Moreover, the term “exemplary,” as used herein, is not provided to convey any qualitative assessment, but instead merely to convey an illustration of an example. Further, the term “montage”, as used herein, may refer to a media file or a multimedia file comprising one or more media files or multimedia files, or one or more portions thereof, arranged so that the one or more media files or multimedia files join, overlap, or blend with one another. In this regard, the terms “media file” and “multimedia file” may be used interchangeably to refer to various forms of content. For example, a montage may refer to an image comprising one or more additional images or portions thereof, such as, for example, photographs or graphical images. These additional images may be associated with a user platform or device, such as, for example, stored on a storage device locally or remotely associated with the user platform or device. The regions and/or portions of existing images may be arranged so as to join, overlap, or blend with one another. Additionally, the terms “metadata,” “tag,” and “geotag” may be used interchangeably herein to refer to information associated with a media file. The information may relate to the media file. Thus, use of any such terms should not be taken to limit the spirit and scope of embodiments of the present invention. Further, it will be appreciated that the scope of the invention encompasses many potential embodiments in addition to those illustrated and described herein.

Although an example embodiment will be described below primarily in the context of generating a montage of images and/or the like, some embodiments could be practiced in the context of other media files, multimedia files, or other types of content such as, for example, audio, videos, movies, applications, texts, books, articles, journals, and/or the like. As such, an example embodiment will be described below primarily in the context of generating a montage based at least in part on detecting or recognizing the face of one or more individuals represented in one or more reference images. For example, a montage may be generated with one or more images associated with the face of a person, such as, for example, a user contact detected in a reference image or the actual user. Nevertheless, some embodiments could be practiced in the context of generating montages based at least in part on detecting other portions of the person's body or other information in the image such as, for example, objects, places, monuments, pets, and/or the like. Further, although an example embodiment will be described below primarily in the context of associating user contact and other related information to the media file, some embodiments could be practiced in the context of associating keywords, text, and/or the like to the media file.

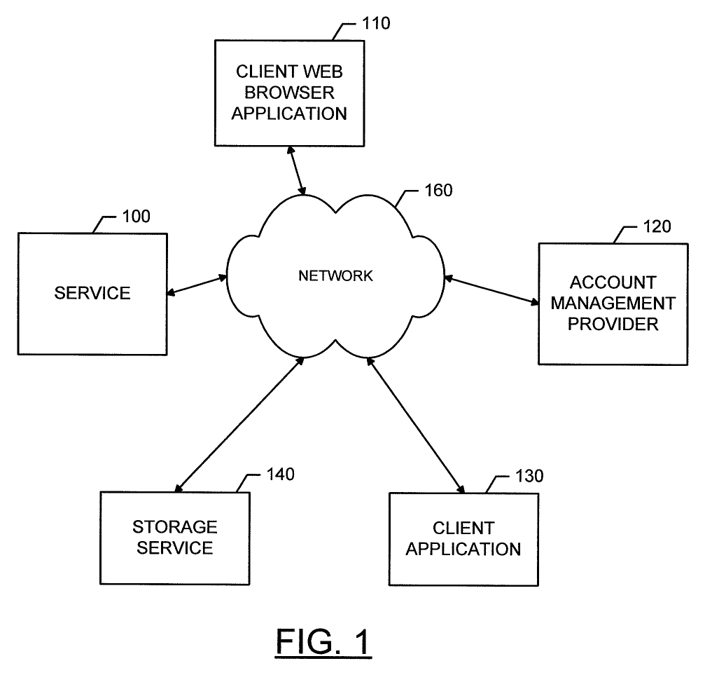

Referring now to FIG. 1, an embodiment of a system in accordance with an example embodiment of the present invention is illustrated. The system of FIG. 1 may include a service 100, a client web browser application 110, an account management provider 120, a client application 130, and a storage service 140. The service 100, the client web browser application 110, the account management provider 120, the client application 130, and the storage service 140 may be interconnected via the illustrated network 160. Furthermore, each of the service 100, the client web browser application 110, the account management provider 120, the client application 130, and the storage service 140 may be any device or means embodied in hardware, software or a combination of hardware and software configured for the performance of the corresponding functions of the service 100, the client web browser application 110, the account management provider 120, the client application 130, and the storage service 140, respectively, as described below.

In an example embodiment, the service 100, the account management provider 120, and the storage service 140, which may include memory, may collectively represent, be incorporated in and/or employ an internet or network service (e.g., a website, a social networking website, a media file storage website, a blog website, a web feed, a widget, a service platform, a server, and/or the like) that may receive and interact with requests from users via the client application 130 and/or the client web browser application 110. The service 100 and the account management provider 120 may be a server or other computing device executing software stored in memory, such as in the storage service 140, for performing the functions described hereinbelow. Various types of one or more media files, multimedia files and/or content, such as, but not limited to, images, music, audio, videos, text, games, profile information, privacy options, and/or the like, may be synchronized with and/or otherwise transferred to and from the service 100. The service 100 may also enable users to transact business to acquire, upload, modify and/or update one or more media files, multimedia files, and other types of content via the service 100. In some cases, the service 100 may enable users to utilize the storage service 140 for storage and retrieval of one or more media files, multimedia files, and other types of content.

The account management provider 120 may operate together with the various other network entities to perform account management and security features. In some embodiments, login information and passwords are first directed to the account management provider 120 for verification. Upon verification, the account management provider 120 may provide access to, and allow communications between various network entities using, for example, a token or other access key.

Client application 130 may be a hardware or software application residing and operating on a platform (e.g., a user platform), such as a computer, mobile terminal, and/or the like, that may be used to interact with the service 100. The client application 130 may be downloaded to and/or installed on the platform. In some embodiments, the client application 130 may be specifically tailored to interact with the service 100, that is, the client application 130 may be a dedicated application. Via the client application 130, the platform, and the user of the platform, may interact with the service 100 to send, receive, and/or modify, as well as synchronize, one or more media files, multimedia files, and other types of content between the client application 130 and the service 100. The client application 130 may facilitate the gathering and storage of one or more media files, multimedia files, and other types of content for subsequent transmission to the service 100.

Similar to the client application 130, the client web browser application 110 may be a hardware or software application residing and operating on a platform (e.g., a user platform), such as a computer, mobile terminal, and/or the like, that may be used to interact with the service 100. In this regard, the client web browser application 110 may be a generic network communication application for interacting with various network entities, including the service 100. Via the client web browser application 110, a platform, and the user of the platform, may interact with the service 100 to send, receive, and/or modify, as well as synchronize, one or more media files, multimedia files, and other types of data between the client web browser application 110 and the service 100. The client web browser application 110 may facilitate the gathering and storage of selections of privacy options and other data for subsequent transmission to the service 100.

In an example embodiment, the service 100 may provide users accessing the service 100 via the client application 130 or the client web browser application 110 with access to various media files, multimedia files, and various types of content. In other cases, a user may be accessing the service 100 via multiple platforms or devices. In this regard, access may be granted if the login information and password are verified. In some situations, a user may search for or otherwise access one or more specific media files, multimedia files, and other types of content (e.g., information related to one or more user contacts) desired by the user. In other situations, the user may associate information to one or more media files, multimedia files, and other types of content desired by the user. In yet other situations, the user may request the generation of at least one montage of one or more media files, multimedia files, other types of content, or any combination thereof based on information associated with at least one specific media file, multimedia file, other types of content, or any combination thereof. In some cases, the request to generate at least one montage may be made with multiple platforms or devices. For example, a user may use one platform to request the generation of a montage and another platform to request the generation of a same or different montage. In this regard, the generated montage may be provided for display or reproduction (e.g. printed), forwarded to or otherwise shared with, and/or used to communicate with other users via various communication methods (e.g., phone call, short message service (SMS) message, multimedia messaging service (MMS) message, e-mail, instant messaging, other messaging protocol, and/or the like, or any combination thereof). For example, a user may call and simultaneously send the montage to at least one individual represented in the image via email, SMS, and/or MMS. The generated montage may be stored on a storage device associated with the service 100 and, by, for example, selecting the individual or on a storage device associated with a user platform.

According to some embodiments of the present invention, the service 100 (or the device of the user (e.g., via the client web browser application 110 or the client application 130)) may provide at least one montage of one or more media files associated with at least one specific media file selected by the user. In this regard, the montage may comprise, one or more media file associated with the user (e.g., images stored on a storage device locally or remotely associated with the user platform) and the one or more media file may be searched, retrieved and selected based on information received by the service 100 that may relate to the specific media file selected by the user. For example, a user may submit a request for a montage for example of images associated with a specific person represented in an image selected by the user. The various information received by the service 100 along with the request may comprise a unique identifier for the media file selected by the user (i.e., the image identifier), other information related to the media file or a portion thereof (e.g., coordinates (e.g. Cartesian coordinates) of a region of the image or a specific position, for example including the face of a specific user), and the number of media file(s) to be used to generate the montage. According to other embodiments, instead of generating a montage, the one or more media files may be searched and retrieved based on information received by the service 100 that may relate to the specific media file selected by the user, and the information relating to the retrieved media file (e.g., media unique identifier, user contact information, etc.) may be provided to the user. According to yet other embodiments of the present invention, the service 100 (or the device of the user (e.g., via the client web browser application 110 or the client application 130)) may provide for the addition of a tag to at least one specific media file selected by the user or a portion thereof, such as, for example, user contact information, keywords and text.

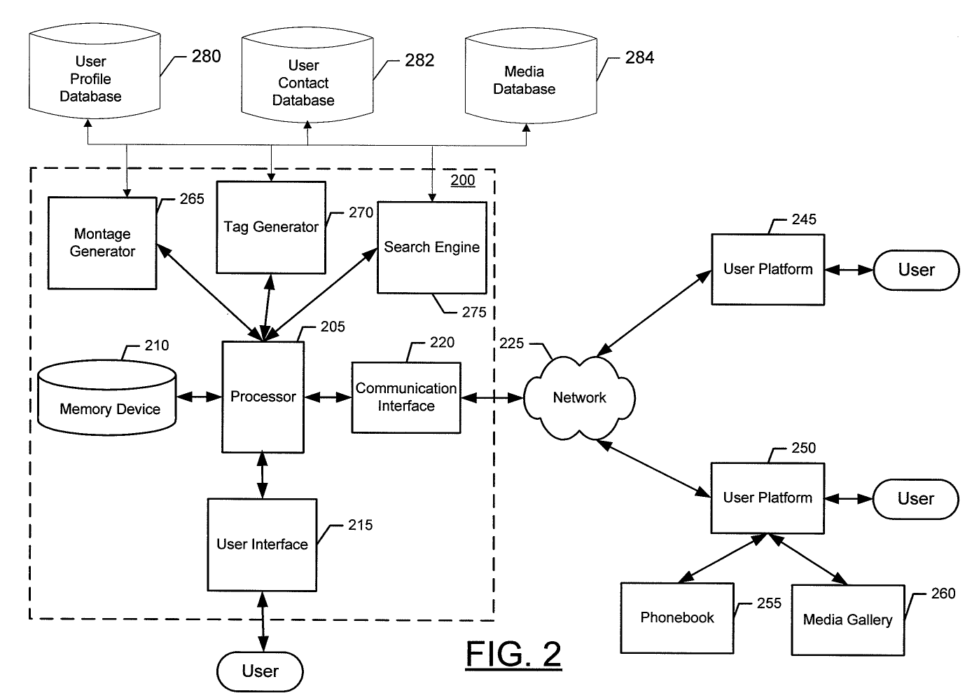

An example embodiment of the invention will now be described with reference to FIG. 2, in which certain elements of an apparatus for generating at least one composite media file are displayed. The apparatus 200 of FIG. 2 may be employed, for example, on a mobile terminal (e.g., mobile phone, mobile communication device, laptop, PDA, mobile telephone, audio/video player, camera, camcorder, GPS device, television, radio, game device and/or the like), server, personal computer, service provider, electronic device capable of running the service 100 or the client web browser application 110 or the client application 130 of FIG. 1, and/or the like. However, it should be noted that the apparatus 200 of FIG. 2, may also be employed on a variety of other devices, both mobile and fixed, and therefore, embodiments of the present invention should not be limited to application on devices such as those listed above. Alternatively, embodiments may be employed on a combination of devices including, for example, those listed above. Moreover, embodiments of the present invention may be embodied wholly at a single device or by a combination of devices such as when devices are in a client/server relationship. Furthermore, it should be noted that the devices or elements described below may not be mandatory and thus some may be omitted in certain embodiments.

Referring now to FIG. 2, an apparatus 200 for generating at least one composite media file is provided. The apparatus 200 may include or otherwise be in communication with a processor 205, a user interface 215, a communication interface 220 and a memory device 210. The memory device 210 may include, for example, volatile and/or non-volatile memory. The memory device 210 may be configured to store information, data, applications, instructions and/or the like for enabling the apparatus to carry out various functions in accordance with example embodiments of the present invention. For example, the memory device 210 could be configured to buffer input data for processing by the processor 205. Additionally or alternatively, the memory device 210 could be configured to store instructions for execution by the processor 205. As yet another alternative, the memory device 210 may be one of a plurality of databases that store information and/or media content.

The processor 205 may be embodied in a number of different ways. For example, the processor 205 may be embodied as various processing means such as a processing element, a coprocessor, a controller or various other processing devices including integrated circuits such as, for example, an ASIC (application specific integrated circuit), an FPGA (field programmable gate array), a hardware accelerator, and/or the like. In an example embodiment, the processor 205 may be configured to execute instructions stored in the memory device 210 or otherwise accessible to the processor 205.

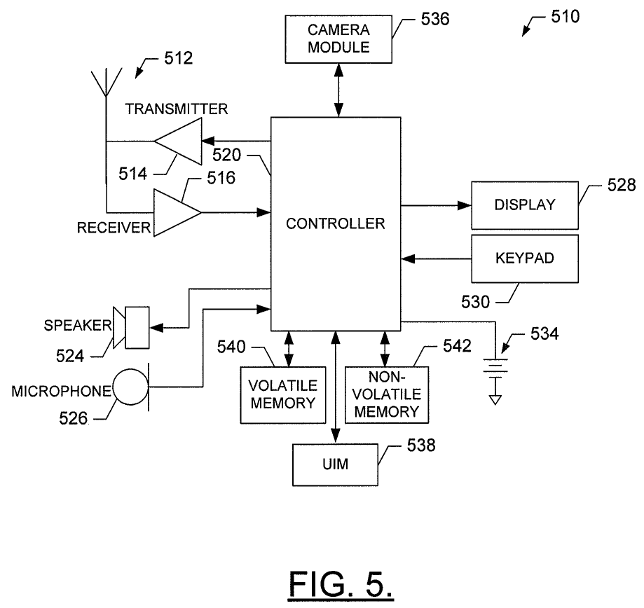

The user interface 215 may be in communication with the processor 205 to receive an indication of a user input at the user interface 215 and/or to provide an audible, visual, mechanical or other output to the user. As such, the user interface 215 may include, for example, a keyboard, a mouse, a joystick, a touch screen, a display, a microphone, a speaker, or other input/output mechanisms. For example, in an embodiment in which the apparatus 200 is embodied as a mobile terminal (e.g., the mobile terminal 510 of FIG. 5), the user interface 215 may include, among other devices or elements, any or all of the speaker 524, the ringer 522, the microphone 526, the display 528, and the keyboard 530. In an example embodiment in which the apparatus is embodied as a server, access point or some other network devices, the user interface 215 may be limited, or eliminated.

Meanwhile, the communication interface 220 may be embodied as any device or means embodied in either hardware, software, or a combination of hardware and software that is configured to receive and/or transmit data from/to a network and/or any other device or module in communication with the apparatus. In this regard, the communication interface 220 may include, for example, an antenna, a transmitter, a receiver, a transceiver, a network card, network adapter, network interface card and/or supporting hardware or software for enabling communications with network 225, which may be any type of wired or wireless network. The communication interface 220 may enable the receipt and transmission of communications with remote devices (e.g., a contacts server 240, a user platform 245 and 250, or the like).

For example, in an embodiment in which the apparatus 200 is embodied as a mobile terminal (e.g., the mobile terminal 10 of FIG. 1), the communication interface 225 may include, among other devices or elements, any or all of an antenna 12, a transmitter 14, a receiver 16, a radio frequency (RF) transceiver and/or interrogator 64, an infrared (IR) transceiver 66, a Bluetooth™ (BT) transceiver 68, an internal voice coder (VC) 20a, and an internal data modem (DM) 20b. As used herein, “communications” and “communication events” may be used interchangeably and may include, but are not limited to, phone calls, SMS messages, MMS messages, e-mails, Internet Protocol communication and/or the like, and transfer or other sharing of files between the apparatus 200 and the remote devices. Sometimes as used herein, the generic term “messages” may be used to refer to SMS messages, MMS messages, e-mails, file transfers and/or the like. As such, via the communication interface 220 and the network 225, the apparatus 200 may communicate with the user platform 245, and/or the user platform 250.

In fixed environments, the communication interface 220 may alternatively or also support wired communication. As such, the communication interface 220 may include a communication modem and/or other hardware/software for supporting communication via cable, digital subscriber line (DSL), universal serial bus (USB) or other mechanisms.

The user platforms 245, 250 may also be any type of device for storing, retrieving, computing, transmitting and receiving data. In some embodiments, user platforms 245, 250 may be embodied as a mobile terminal 510 of FIG. 5 discussed below or the like. Alternatively, the user platforms may be fixed, such as in instances in which a work station serves as a user platform. User platforms may be associated with one or more user contacts such that a user contact may be used to direct communications to the user platforms and a user of the user platform, and vice versa. User platforms 245, 250 may be representative of a plurality of user platforms, and as such any number of user platforms may be included in FIG. 2. In some embodiments, via the user platforms 245, 250, a user may access an example online service such as, but not limited to, a website, a social networking website, a media storage website, a blog website, a web feed, a widget, or the like, using a browser, a dedicated application, or the like.

The user platform 250, as well as any other user platform, may also be associated with a phonebook 255. The phonebook 255 may include data comprising user contact information and/or additional related information. The phonebook 255 may be stored on a memory device that is locally associated with the user platform 255 (e.g., internal and/or external memory) or remotely associated with the user platform 250 (e.g., the user contact database 282, a storage device associated with a social networking website). Similarly, the user platform 250, as well as any other user platform, may also be associated with a media gallery 260. The media gallery 260 may store various types of one or more media files comprising images, audio, video, music, movies, etc. The media gallery 260 may be stored on a memory device that is locally associated with the user platform 255 (e.g., internal and/or external memory) or remotely associated with the user platform 250 (e.g., the media database 284, a storage device associated with a social networking website or media storage website). As described below, the data of the phonebook 255 and/or the media gallery 260 may be synchronized with, for example, the user contact database 284 and/or the media database 284, respectively.

In an example embodiment, the processor 205 may be embodied as, include or otherwise control a montage generator 265, a tag generator 270 and a search engine 275. Although they may be embodied by the processor 205, the montage generator 265, the tag generator 270 and the search engine 275 may each be any means such as a device or circuitry embodied in hardware, software or a combination of software and hardware (e.g., a suitably programmed processor, combinational logic circuit, and/or the like), computer code (e.g., software or firmware) embodied on a computer-readable medium (e.g. memory device 210) that is executable by a suitably configured processing device (e.g., the processor 205), or some combination thereof and/or that is configured to perform the corresponding functions of the montage generator 265, the tag generator 270 and the search engine 275, respectively, as described below. The montage generator 265, the tag generator 270 and the search engine 275 may each or collectively include one or more of means for receiving an indication of information associated with at least a first media file, means for submitting a search request for information associated with at least a second media file based at least in part on the information associated with the at least first media file, means for receiving the information associated with the at least second media file, means for generating a composite media file based at least in part on the information associated with the at least second media file, and means for providing for display of the composite media file. Further, either or all of the montage generator 265, the tag generator 270 and the search engine 275 may be in communication one with another.

Either or all of the montage generator 265, the tag generator 270 and the search engine 275 may be in communication with one or more databases that may store information useful in connection with embodiments of the present invention. In an example embodiment, one or more of the databases may be associated with a service platform (e.g., service 100). The databases may include, for example, a user profile database 280, a user contact database 282, and a media database 284 and/or the like. One or more of the databases may be a portion of the memory device 210. However, one or more of the databases may alternatively be separate databases accessible by the montage generator 265, the tag generator 270 and the search engine 275 via the communication interface 220 and/or the network 225.

Moreover, one or more of the databases may store data identical or similar to the data stored on an internet or network service, a user platform, or other devices in communication with apparatus 200. Additionally or alternatively, data stored on one or more databases in one location (e.g., apparatus 200, user platform, internet or network service) may also be stored on a corresponding one or more databases of the other locations (e.g., apparatus 200, user platform, internet or network service). As such, data stored on the database of one location (e.g., apparatus 200, user platform, internet or network service) may be readily identified if stored on a corresponding database of another location (e.g., apparatus 200, user platform, internet or network service). For example, a user may upload one or more media files (e.g., one or more images) from the user platform to the media database 284. One or more components of the apparatus 200 may be configured to parse the uploaded data and store the data in the media database 284. Similarly, one or more components of the apparatus 200 may be configured to cause the uploaded data to be uploaded and stored on corresponding database associated with an internet or network service. As such, the one or more media files may be stored on different locations (e.g. a storage device associated with a user platform, media database 284 of apparatus 200 and a storage device associated with internet or network service).

Additionally, data stored on a user contact database 282 and a media database 284 may be synchronized with and/or otherwise transfer to and from a user platform, an internet or network service, or other devices in communication with apparatus 200. For example, a user may submit a request to synchronize the one or more media files stored on the user platform, including the associated tags, with the media database 284 and/or a corresponding database associated with a social networking website. In this regard, one or more components of the apparatus 200 may receive the media files and associated tags from the user platform, parse the received information to identify the data not stored on the media database 284 and/or the corresponding database on the social networking site, and cause the missing data in each respective database (media database 284 and/or the corresponding database on the social networking site) to be stored thereon. As a further example, the user contact database 282 and the media database 284 may synchronize with, transfer to and from, and/or store data identical or similar to data stored on the phonebook 255 and the media gallery 260, respectively, and vice versa. Similarly, the user contact database 282 and the media database 284 may synchronize with, transfer to and from, and/or store data identical or similar to data stored on corresponding databases associated with an internet or network service, and vice versa.

The user profile database 280 may store information regarding user credentials, user preferences, information descriptive of user interests, historical data regarding user content consumption or habits, contact information and/or the like. As such, the user profile database 280 may store unique user identifiers, usernames, user passwords, information indicative of the types of montage, the type of media (e.g., images, music, videos, etc.), the media format (e.g., Joint Photographic Experts Group (JPEG), Graphics Interchange Format (GIF), Portable Network Graphics (PNG), Moving Picture Experts Group (MPEG), MPEG-1 Audio Layer 3 (MP3), etc.), the number of one or more media files to be used, the manner of reformatting the one or more media files (e.g., cropping, resizing, scaling, etc.), the arrangement of the one or more media files in the montage, and the information contained in the one or more media files preferred by the user when generating the montage. The information contained in the media files may comprise images of specific people (e.g., family, friends, coworkers, etc.), specific periods of time (e.g., evenings, weekends, holidays, etc.), and geographic locations (e.g., countries, landmarks, beaches, etc.). The information stored in the user profile database 280 may be used, for example, by the montage generator 265, the tag generator 270 and the search engine 275 for retrieving one or more media files to be used in generating the montage. For example, one user preference may be images of family members during the holidays in exotic places, such as Africa. Further, the users stored on the user profile database 280 may be subscribers to the service 100.

The user contact database 282 may store various information regarding user contacts. As such, the user contact database 282 may store unique user contact identifiers, first and last names, contact information (e.g. telephone and/or facsimile number(s), e-mail and/or regular mail address(es), instant messenger usernames, etc.), and the unique identifier(s) of the user(s) (e.g., the unique identifiers from the user profile database) to whom a user contact is associated. In this regard, information relating to user contacts may be synchronized with and/or otherwise transferred back and forth between the user contact database 282 and various devices, such as, for example, the user platform 245 and/or 250, and a social networking website. For example, a user may upload one or more user contacts to the user contact database 282 from the user platform 250 via, for example, network 225. Conversely, a user may update one or more user contacts maintained on the user contact database 282 via, for example, network 225, and then download/transfer to the user platform 245 and/or the user platform 250, via, for example, network 225. Similarly, a user may exchange or share one or more user contacts with another user, using respective user platforms 245 and 250, in other words uploading or updating one or more user contacts between the user platforms, via, for example, network 225. Further, a user contact may be associated with one or more users from the user profile database. Moreover, information regarding one or more user contacts may be associated with one or more media files, as described below.

The media database 286 may store various information regarding one or more media files comprising unique media identifier(s), media path(s), and one or more tags associated with each media file. Each metadata may comprise information relating to at least one media file or a portion thereof (e.g. the coordinates or specific position of a region of an image), user contact information, keywords, text, and/or the like. The metadata may provide for learning information about a particular content item for use in filtering, searching and/or generating In some embodiments, the tags associated with each media file may be stored in a separate metadata database (not shown). As such, the metadata database may store various information regarding one or more media files comprising unique media identifier(s), media paths, information relating to at least one media file or a portion thereof (e.g. the coordinates or specific position of a region of an image), user contact information (e.g., user contact unique identifier, names, phone numbers, and addresses), and/or the like. In some embodiments, the media database 286 may store one or more media files such as, for example, images and/or the like while in other embodiments, the media database 286 may store various types of media files, multimedia files, and other types of content such as, for example, images, music, videos, movies, electronic texts, applications and/or the like.

The search engine 275 may be configured to perform searches for information associated with or related to at least one specific media file selected by the user (e.g., image identifier(s), image path(s), tag(s) associated therewith, a number of one or more media files to be used in generating the montage) relating to the specific media file based at least in part on information associated with the specific media file (e.g., image identifier and coordinates or specific position of a region of the image). For example, the apparatus 200 may be configured to detect the face of at least one individual represented in the reference image based on its location on the image and as such, the search may be based the face of the individual. In this regard, the individual may be a contact of the user. In some embodiments, the information associated with one or more media files may be used in generating one or montages. The search engine 275 may also be configured to search various ones of the databases associated with the apparatus 200, namely the user profile database 280, the user contact database 282, and the media database 284, the metadata database, and/or the like.

Additionally or alternatively, the search engine 275 may be configured to perform searches for other information relating to at least one specific media file selected by the user based at least in part on information associated with the specific media file. In this regard, the other information relating to the specific media file may include, for example, user contact information associated or relating to the specific media file, tags associated with or relating to the specific media file or tags. In other embodiments, the montage generator 265 may receive the information associated with the specific media file selected by the user and communicate the information to or otherwise instruct the search engine 275 to perform the search. Additionally or in the alternative, the search engine 275 may also search the user profile database 280 to determine the preference(s) of the user based at least in part on the unique identifier of the user submitting the search request and filter the retrieved one or more media files and/or other information relating to the specific media file based at least in part on the user preference(s). In an example embodiment, the search engine 275 may be configured to parse the information associated with one or more specific media files selected by the user.

In some embodiments, a user may submit a search request for one or more media files or other information related to at least one specific media file desired by the user. For example, the search engine 275 may receive information associated with a specific image or reference image selected by the user, such as, for example, an image. The information may comprise, for example, the unique identifier of at least one specific image and the coordinates or specific position of at least one region or portion of the image (e.g., Cartesian coordinates), and the number of media files to be used. The search engine 275 may then perform a search of media files and/or other information associated with or relating to the received information. As mentioned above, the search engine 275 may be in communication with one or more databases (e.g., the user profile database 280, the user contact database 282, the media database 284, and the metadata database). In some embodiments, the search engine 275 may perform a search of the media database 284 to retrieve one or more media files associated with the received information based at least in part on the received information. In this regard, the search engine 275 may search the media database 284 for an image with a unique identifier matching that of the specific image.

The search engine 275 may perform a search to identify any metadata or tags associated with the reference image and more specifically, any metadata or tags with a specific region or portion based at least in part on the coordinates or specific position of the region or portion of the reference image. In some embodiments, the search engine 275 may perform a search to identify any tags associated with the reference image based at least in part on the unique identifier of the image. In this regard, the search engine 275 may identify all the tags associated with the reference image and then identify the tag including coordinates that are proximate to the received coordinates associated with the reference image. For example, the search engine may identify the tag having coordinates that are the closest to or the most proximate to the received coordinates, and/or that are within a predefined distance of the received coordinates. The tag may also comprise information associated with a user contact such as, for example, unique user contact identifier, first and last names, e-mail addresses, and telephone numbers. Alternatively or additionally, the tag may comprise other information, such as, for example, keywords, or text, associated with the region of the reference image. In some embodiments, a tag may only comprise a unique user contact identifier. As such, the search engine 375 may search the user contact database to retrieve information associated with the unique user identifier such as, for example, first and last names, contact information (e.g. telephone and/or facsimile number(s), e-mail and/or regular mail address(es), instant messenger usernames, etc.), and the unique identifier(s) of the user(s) to whom the user contact is associated.

The search engine 275 may then perform a search in the media database 284 to retrieve all the media files associated with the information included in the identified tag (or each identified tag) based at least in part on that information. For example, the search engine 275 may perform a search to retrieve all the media associated with a user contact included in the identified tag based at least in part on the information associated with the user contact. The search may retrieve a unique identifier(s) for image(s), images path(s), and the tags associated with the image(s), for all the images including the information of the identified tag. The search may be based at least in part on comparing the information included in the tags associated with each media file with the information included in the identified tag. For example, a search may be based at least in part on unique user contact identifier included in the identified tag and as such, for each user contact identifier, the search engine 275 may query the media database 284 to identify all the images associated with the user contact identifier.

The tag generator 270 may be configured to generate one or more tags based on content represented in at least one specific media file selected by the user (e.g., person, objects, monument, geographical location, etc.). In this regard, the tag generator 270 may be configured to associate information with at least one specific media file or at least one selected portion or region thereof. In some embodiments, the tag may be associated with a media file or selected portion thereof based at least in part on a location relative to the size of the media file. The generated tag may comprise a unique identifier of a media file, information relating to a portion of the media file (e.g., coordinates or specific position of an image or portion thereof), and additional information such as, for example, user contact information (e.g., names, telephone number(s), e-mail address(es), instant messenger information, etc), keywords, and text. For example, the user may submit a request to generate a tag for a desired area of a selected image. The desired area may correspond to the face of an individual. The tag generator 270 may receive information relating to the selected image comprising the identifier of the image, the coordinates (e.g., Cartesian coordinates) or specific position of the desired area, and the information relating to the individual (e.g., first and last names).

The tag generator 270 may be in communication with one or more databases associated with the apparatus 200, including the user contact database 282, the media database 284 or the metadata database. As such, the tag generator 270 may be configured to parse the received information, generate the tag(s) and cause the tags generated to be stored in the media database 284 or the metadata database in association with the respective image for which the tag was generated. In the alternative, the tags may also be stored on the memory device 210 or a storage device external to the apparatus 200. Additionally, the generated tags may also be stored on the user platform in association with the media file selected by the user, or on a corresponding storage device of an internet or network service. One or more tags may be associated with each media file. In some embodiments, the tag may be generate based on an individual represented in the media file and the individual may be a contact of the user. As such, the tag generator 270 may cause the search engine 275 to retrieve the identifier of the contact from the user contact database 282 and/or the contact information and store the identifier and/or the contact information with the generated tag. In this regard, one or more user contact identifier may be associated with a media file.

The montage generator 265 may be configured to generate one or more montages based on at least in part on one specific media file selected by the user. In this regard, the montage generator 265 may receive information associated with at least one specific media file selected by the user such as, for example, image identifier(s), image path(s), tag(s) associated therewith, a number of media files to be used in generating the montage, and coordinates of a region of the image. As mentioned above, either or all of the montage generator 265, the tag generator 270 and the search engine 275 may be in communication one with another. As such, the montage generator 265 may be configured to cause the search engine 275 to perform a search for all media files relating to the received information described above. The search may return at least one media file. In the event the search returns only one media file, at least one additional media file that may be unrelated to the search (“filler media file”) may be utilized in generating the montage. The filler media file may be predetermined or may be randomly selected from a group of filler media. These filler media files may be stored on a storage device associated with the montage generator 265. In some embodiments, the storage device may be locally connected to the montage generator 265, such as, for example, the memory device 205 or a dedicated montage template storage device (not shown), while in other embodiments, the storage device may be remotely connected to montage generator 265 via a network.

In some embodiments, the montage generator 265 may receive the number of images that will be used in the montage (N) and the identifiers (ucids) of the one or more individuals based on which the montage may generated (as mentioned above, the search engine may retrieve user contact identifiers (ucids) based at least in part on information associated with at least one media file). For each ucid, the montage generator 265 may be configured to cause the search engine 275 to search for a list of image identifiers (iids), the image paths (iPaths), and their associated tag lists, which tags may include ucids and other user contact information. The montage generator may be configured to select a minimum number (mirN) of images based at least in part on N. In this regard, minN may be a number between N and the returned number of iids, equal to N or the number of returned images, in the event that the number of returned images is less than N. The montage generator 265 may select the images to be used in generating the montage through a randomized process or a more structured process based on various criteria. In some embodiments, the user may be presented with the retrieved images and given the opportunity to select at least one desired image. For each selected iid, the montage generator 265 may open the images using each iPath and modify the image based on at least part on various criteria, such as, for example, the individuals represented in the image, the position or geographic location of the individuals or their faces, and/or temporal information (e.g. date and time of creation of the image), included in each tag list retrieved from the media database 284. In this regard, the montage generator 265 may modify the actual image or a copy thereof.

The modification of the media file may comprise cropping and scaling. In this regard, the tags associated with the media file may be maintained because the tag may be associated based at least in part on a location relative to the size of the media file. The montage generator 265 may also determine the positioning of the images based at least in part on the same or different criteria as the ones above. In some embodiments, the size or dimension of the first image in the list of returned iPaths may be used to determine the size or dimension of the montage. In other embodiments, the size or dimension of the montage may be predefined. In yet other embodiments, the size or dimension of the montage may be based at least in part on the user preference. In this regard and as an example, given the desired size or dimension of the montage, the montage generator 265 may divide the montage into at least two portions, divide the minN by two (halfMinN), and position halfMinN of the images side by side on the bottom half of the montage, and halfMinN images (or halfMinN+1 if mirN is an odd number) on the top half of the montage. The thus generated montage may then be saved on a storage device associated with the montage generator 265 and sent to the user platform to be stored on, for example, media gallery 260. In some embodiments, the storage device may be locally connected to montage generator 265, such as, for example, memory device 210, media database 284, or a dedicated montage storage device (not shown). In other embodiments, the storage device may be remotely connected to montage generator 265 via a network. In some embodiments, the montage may be generated with one or more media files associated with the user platform, such as, for example, media files stored in media gallery 260. In other embodiments, the montage may be generated with one or more media files retrieved from media database 284. In yet other embodiments, the montage may be generated with one or more media files retrieved from a storage device associated with an internet or network service site, such as, for example, a social networking website.

In some embodiments, the montage may be based on at least one montage template. The montage templates may be predefined by default settings of the apparatus 200. In this regard, one or more montage templates may be stored on a storage device that may be associated with the montage generator 265. In some embodiments, the storage device may be locally connected to the montage generator 265, such as, for example, the memory device 205 or a dedicated montage template storage device (not shown), while in other embodiments, the storage device may be remotely connected to montage generator 265 via a network. In yet other embodiments, the montage may be based on the preference of the user. As discussed above, the user profile database 280 may store the montage preference of a user. In this regard, the montage generator 265 may cause the search engine 275 to retrieve the preferences and may generate a montage based on the user's preferences. In yet other embodiments, the user may have a selection of preferred templates that may be ordered by liking. Moreover, the preferred templates may be customized by the user.

The montage may comprise one or more individuals, or the actual user. In some embodiments, all or some of the individuals may be contacts of the user. The montage may be generated based at least in part on user selection of a media file, or a portion thereof. The information of one or more images retrieved from the search engine may then be used in one form or another to create the montage. Each portion of the montage wherein an individual or the user may be located may be associated with a tag comprising contact information of the individual or user (e.g., telephone number(s), e-mail address(es), instant messenger information, etc). In this regard, the montage may maintain the tag(s) associated with each media file used in generating the montage. As such, a user may communicate with one or more individuals via the various methods of communication as discussed above, by selecting or clicking on one or more individuals. For example, the user may send a SMS to an individual by selecting or clicking on the individual in the montage. In this regard, the SMS may include a link to the location of the montage (e.g., at an internet or network service) and a message to the individual. As another example, the user may send a MMS or an e-mail to an individual by selecting or clicking on the individual in the montage. In this regard, the MMS or e-mail may include the actual montage and a message to the individual. As a further example, the user may call and simultaneously send a message (e.g., SMS, MMS, e-mail, and/or the like) to an individual by selecting or clicking on the individual in the montage. In this regard, the message may include a link to the location of the montage, the actual montage, and/or a message to the individual. In some embodiments, a user may simultaneously communicate with all the individuals in the montage.

As mentioned above, some embodiments could be practiced in the context of generating a montage with other media files, multimedia files, and/or the like. In this regard, although the discussion has been focusing on generating montages of images, this concept may be further extended to generate a montage of audio files, video files, movies, any combination thereof, and/or the like. In this regard and as an example, a custom playlist may be built. As such, along with the existing metadata information such as, for example, artist(s) or actor(s), album(s), title(s), and genre(s), a user may also provide additional metadata such as, for example, ratings, personal annotations, temporal information (e.g., date and time) associated to the execution of the media file (e.g., the music was played at a certain date and time), weather information, location information, call log information, and/or the like. In this regard, the montage may be generated based at least in part on the metadata associated with the media file in accordance with a predefined template. Additionally, the montage may be generated in accordance with user preference(s) which may include, for example, the number of media file to be used, the duration of the generated compilation, the duration of each media file, the genre(s), artist(s) or actor(s), album(s), etc. For example, a generated montage may be associated with a trip or time period (e.g., top rated songs for “Rainy day songs”, “Vegas trip songs”, “Songs that I was listening to when you called me”, etc.). The montage may be generated in the same manner as described above. For example, a user may select a music file or a portion thereof that may have metadata associated therewith and submit a request for a montage to be generated based at least in part on the metadata associated with the selected media file or portion thereof. One or more media files may be retrieved wherein some or all of the retrieved media files may be selected to generate the montage.

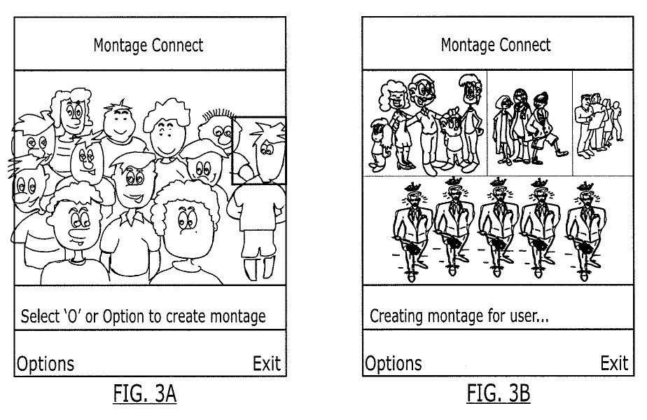

Referring now to FIG. 3A, an example graphical representation according to an example embodiment of the present invention is illustrated. The graphical representation comprises a media file (e.g., image) selected by a user. The selected image comprises three individuals and several objects. Each of the individuals and objects may have a tag associated therewith. As such and as mentioned above, each one of the individuals and/or objects may be selected by the user to generate a montage based at least in part on each individual and/or objects. In some embodiments, a graphical symbol may be placed around a portion of a media file to indicate that the user has selected that portion of the media file. Further, the selected portion may correspond to a portion of the image associated with a tag. A user may be able to navigate various portions of a desired image and select one or more pieces of content in the image (e.g., individuals or portions of their bodies, objects and/or the like). In the present example, the user may desire a montage based on the selected individual, as indicated by the graphical symbol around the region of the individual's face. In some embodiments, the user may be prompted for an input before the montage may be generated, as seen in FIG. 3A. In other embodiments, the montage may be automatically generated after a graphical symbol has been placed on a portion or region of the media file for a predetermined period of time.

FIG. 3B illustrates a montage generated based at least in part on the selected individual. In this regard, and as seen in FIG. 3B, the montage comprises several images that include the selected individual. One or more of these images may have been modified (e.g., cropped, resized) based at least in part on various criteria as discussed above. Further, the images may have been arranged also based at least in part on the same or different various criteria as discussed above. In some embodiments, a user may select one or more images or portions thereof and, request a montage to be generated based at least in part on the information associated with the one or more images or portions thereof. For example, a montage may be generated from information associated with a first image and two regions of a second image. The montage may be printed and used for various purposes such as, for example, a gift card. As mentioned above, the user may select or click on one or more individuals in the montage and initiate communications with the selected individual(s).

As mentioned above, the service 100, the account management provider 120, and the storage service 140, may collectively be incorporated in an internet or network service. Accordingly, in some embodiments, the service 100 may be accessed through an internet or network service (e.g., a website, a social networking website, a media storage website, a blog website, a web feed, a widget, a service platform, a server, and/or the like). In this regard and as an example, a user may access the service 100 through a social networking website, as one of the services provided by the social networking website.

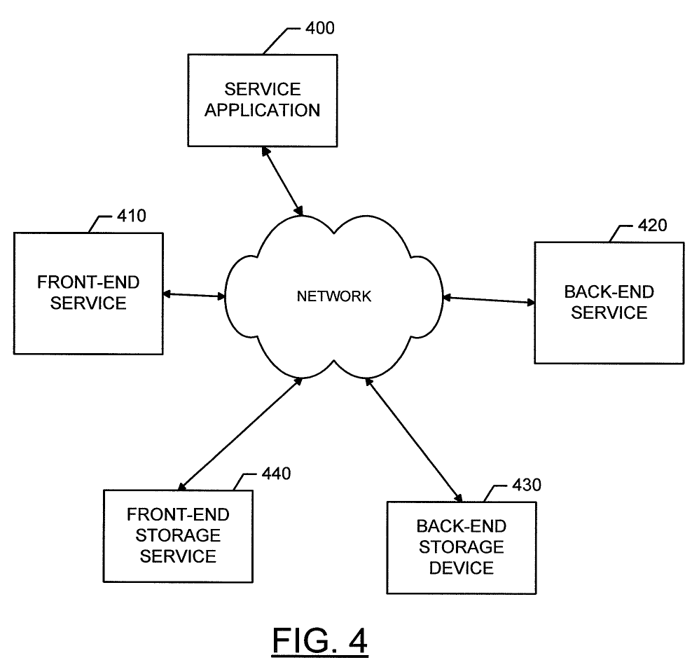

In this regard, and referring now to FIG. 4, an embodiment of a system in accordance with aspects of the present invention is illustrated. The system of FIG. 4 may include a service application 400, a front-end service 410, a back-end service 420, a back-end storage device 430, and a front-end storage service 440. The service application 400, the front-end service 410, the back-end service 420, the back-end storage device 430, and the front-end storage device 440 may be interconnected via the illustrated network, which may operate in similar manner to network 225. The back-end service 410 may be embodied as or provided by apparatus 200 and the back-end service 420 may be an online service. In this regard, the back end service may be a server or other computing device configured to execute software in order to perform its functions. The back-end storage device 430 and the front-end storage device 440 may operate in similar manner to the storage device 205, as discussed herein. The back-end storage device 430 may store one or more media files, one or more tags associated with each media file, user preferences for montages, user contacts, montages, and/or the like. The front end storage device 440 may store information associated with users of the front-end service, one or more user profiles, user contacts, one or more media files, tags associated with each media file, montages, and/or the like. Back-end storage device 430 and front-end storage device 440 may include memory and may be configured to operate like 205. In some embodiments, the back-end storage device 430 and the front-end storage device 440 may be embodied in one storage device that may operate in a similar manner to the storage device 205.

The service application 400 may be a software or hardware application residing and operating on a platform, such as a computer, mobile terminal, or the like, that may be used to interact with the front-end service 410, the back-end service 420, and/or allow the front-end service 410 and the back-end service 420 to interact with each other. In some embodiments, one or more of the front-end service 410, the back-end service 420, the front-end service 410, and the back-end service 420 may reside and operate on a platform, such as a mobile terminal, computer, and/or the like. In some embodiments, the service application 400 may reside and operate on the apparatus 200, the user platforms 245, 250, or the like, and may operate in a similar manner to apparatus 200, the user platforms 245, 250, or the like. The service application 400 may be downloaded to and/or installed on the platform. Via the service application 400, the front-end service 410 and the back-end service 420 may interact with each other to send and receive data, such as achievements, user information, user contacts, and/or the like. The service application 400 may facilitate the gathering and/or storage of media files, tags associated with the media files, user preferences and/or user contacts for subsequent transmission to the front-end service 410 and/or the back-end service 420.

The service application 400 may also include authentication means to provide security features during the interaction between the front-end service 410 and the back-end service 420. The authentication means may be embodied as the processor 205, the front-end service 410, the back-end service 420, and/or the like, and, in one embodiment, may include computer instructions executed by one or more of the foregoing components. For example, the back-end service 420 may authenticate itself via the authentication means before exchanging information and/or accessing information maintained on the front-end storage device 440, and vice versa. Upon verification, the back-end service may be provided with access to, and allowed to exchange information with the front-end service 410, and vice versa.

FIG. 5 illustrates a block diagram of a mobile terminal 510 that may benefit from example embodiments of the present invention. It should be understood, however, that a mobile terminal as illustrated and hereinafter described is merely illustrative of one type of mobile terminal that may benefit from some embodiments of the present invention and, therefore, should not be taken to limit the scope of embodiments of the present invention. Several types of mobile terminals, such as mobile phones, mobile communication devices, portable digital assistants (PDAs), pagers, mobile televisions, gaming devices, all types of computers (e.g., laptops or mobile computers), cameras, camcorders, audio/video players, radio, global positioning system (GPS) devices, or any combination of the aforementioned, and other types of communications systems, can readily employ embodiments of the present invention. The mobile terminal 510 may be an example of the apparatus 200 of FIG. 2. However, as indicated above, the apparatus 200 of FIG. 2 could alternatively be embodied as the service 100 of FIG. 1 or even some other device.

In an exemplary embodiment, the mobile terminal 510 may include a camera module 536 in communication with the controller 20. The camera module 36 may be any means for capturing an image for storage, display or transmission. For example, the camera module 536 may include a digital camera capable of forming a digital image file from a captured image. As such, the camera module 536 may include all hardware, such as a lens or other optical device, and software necessary for creating a digital image file from a captured image. Alternatively, the camera module 536 may include only the hardware needed to view an image, while a memory device of the mobile terminal 510 may store instructions for execution by the controller 520 in the form of software necessary to create a digital image file from a captured image. In an exemplary embodiment, the camera module 536 may further include a processing element such as a co-processor which may assist the controller 520 in processing image data and an encoder and/or decoder for compressing and/or decompressing image data.

The mobile terminal 510 may include an antenna 512 (or multiple antennas) in operable communication with a transmitter 514 and a receiver 516. The mobile terminal 510 may further include an apparatus, such as a controller 520 or other processing element, that provides signals to and receives signals from the transmitter 514 and receiver 516, respectively. The signals may include signaling information in accordance with any of numerous wireless communication standards. In this regard, the mobile terminal 510 may be capable of operating with one or more air interface standards, communication protocols, modulation types, and access types.

It is understood that the apparatus, such as the controller 520, may include circuitry for implementing, among others, audio/video and logic functions of the mobile terminal 510. For example, the controller 520 may comprise a digital signal processor device, a microprocessor device, and various analog to digital converters, digital to analog converters, and/or other support circuits. Control and signal processing functions of the mobile terminal 510 may be allocated between these devices according to their respective capabilities. The controller 520 thus may also include the functionality to encode and interleave message and data prior to modulation and transmission. The controller 520 may additionally include an internal voice coder, and may include an internal data modem. Further, the controller 520 may include functionality to operate one or more software programs, which may be stored in memory. For example, the controller 520 may be capable of operating a connectivity program, such as a conventional web browser. The connectivity program may then allow the mobile terminal 510 to transmit and receive web content, such as location-based content and/or other web page content, according to a Wireless Application Protocol (WAP), Hypertext Transfer Protocol (HTTP) and/or the like, for example.

The mobile terminal 510 may also comprise a user interface including an output device such as an earphone or speaker 524, a microphone 526, a display 528, and a user input interface, which may be operationally coupled to the controller 520. The user input interface, which allows the mobile terminal 510 to receive data, may include any of a number of devices allowing the mobile terminal 510 to receive data, such as a keypad 530, a touch display (not shown) or other input device. In embodiments including the keypad 530, the keypad 530 may include numeric (0-9) and related keys (#, *), and other hard and soft keys used for operating the mobile terminal 510. Alternatively, the keypad 530 may include a QWERTY keypad arrangement. The keypad 530 may also include various soft keys with associated functions. In addition, or alternatively, the mobile terminal 510 may include an interface device such as a joystick or other user input interface. The mobile terminal 510 further includes a battery 534, such as a vibrating battery pack, for powering various circuits that are used to operate the mobile terminal 510, as well as optionally providing mechanical vibration as a detectable output.

The mobile terminal 510 may further include a user identity module (UIM) 538. The UIM 538 is typically a memory device having a processor built in. The UIM 538 may include, for example, a subscriber identity module (SIM), a universal integrated circuit card (UICC), a universal subscriber identity module (USIM), a removable user identity module (R-UIM), etc. The UIM 538 typically stores information elements related to a mobile subscriber. In addition to the UIM 538, the mobile terminal 510 may be equipped with memory. The mobile terminal 510 may include volatile memory 540 and/or non-volatile memory 542. For example, volatile memory 540 may include Random Access Memory (RAM) including dynamic and/or static RAM, on-chip or off-chip cache memory, and/or the like. Non-volatile memory 542, which may be embedded and/or removable, may include, for example, read-only memory, flash memory, magnetic storage devices (e.g., hard disks, floppy disk drives, magnetic tape, etc.), optical disc drives and/or one ore more media files, non-volatile random access memory (NVRAM), and/or the like. Like volatile memory 540 non-volatile memory 542 may include a cache area for temporary storage of data. The memories can store any of a number of pieces of information, and data, used by the mobile terminal 510 to implement the functions of the mobile terminal 510.

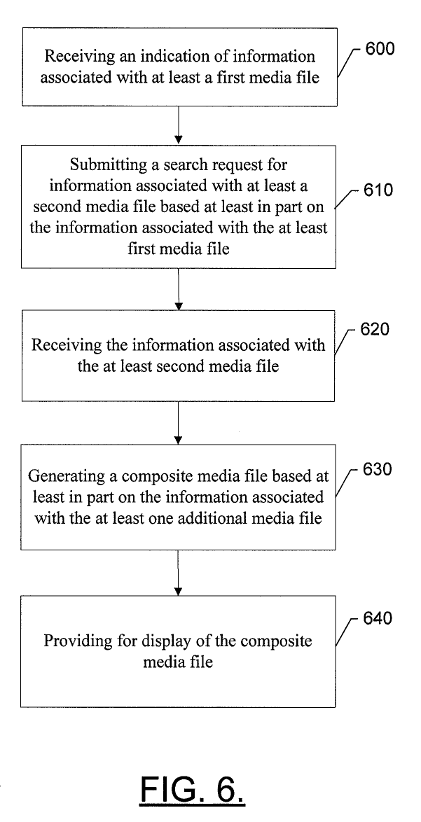

FIG. 6 is a flowchart of a system, method and program product according to example embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device and executed by a processor (e.g., the processor 205). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). Further, the functions specified in the flowchart block(s) or step(s) may be executed in any order. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowcharts, can be implemented by special purpose hardware-based computer systems which perform the specified functions or steps, or combinations of special purpose hardware and computer instructions.

In this regard, one embodiment of a method for generating a composite media file as provided in FIG. 6 may include receiving an indication of information associated with at least a first media file at operation 600 and submitting a search request for information associated with at least a second media file based at least in part on the information associated with the at least first media file at operation 610. The method may further include receiving the information associated with the at least second media file at operation 620. At operation 630, the method may further include generating a composite media file based at least in part on the information associated with the at least second media file. At operation 640, the method may include providing for display of the composite media file.

In some embodiments, receiving an indication of information associated with at least a first media file may include receiving an indication of a number of media files to be used in generating the composite media file. In other embodiments, receiving an indication of information associated with at least one media file may include receiving an indication of information associated with at least one selected portion of the at least first media file. In yet other embodiments, receiving an indication of information associated with at least one selected portion of the at least one media file may include receiving an indication of information associated with a user contact.

In an example embodiment, receiving an indication of information associated with at least one selected portion of the at least one media file may include receiving an indication of coordinates associated with the at least one selected portion. In another example embodiment, generating a composite media file may include modifying the at least second media file based on a predetermined set of criteria including at least one of a user contact represented in the media file, position of a user contact in the media file, a geographic location of a user contact in the media file, or a temporal information associated with the at least first media file.

In some cases, the method may further include communicating with a user contact based at least in part on receiving an indication of a selection of a user contact from the composite media file. In some embodiments, communicating with a user contact may include communicating via various communication methods comprising at least one of a telephone call, short message service (SMS) message, multimedia messaging service (MMS) message, e-mail, instant messaging, or other messaging protocol.

In an example embodiment, an apparatus for performing the method above may include a processor (e.g., the processor 205) configured to perform each of the operations (600-640) described above. The processor may, for example, be configured to perform the operations by executing stored instructions or implement an algorithm for performing each of the operations. Alternatively, the apparatus may include means for performing each of the operations described above. In this regard, according to an example embodiment, examples of means for performing operations 600 to 640 may include, for example, a processor (e.g., the processor 205), the montage generator 265, the tag generator 270, and the search engine 275, any other device or circuitry embodied in hardware, software or a combination of software and hardware (e.g., a suitably programmed processor, combinational logic circuit, and/or the like), computer code (e.g., software or firmware) embodied on a computer-readable medium (e.g. memory device 210) that is executable by a suitably configured processing device (e.g., the processor 205), or some combination thereof and/or that is configured to perform the corresponding functions of the means for performing operations 600 to 640.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving an indication of information associated with at least a first media file;
submitting a search request for information associated with at least a second media file based at least in part on the information associated with the at least first media file;
receiving the information associated with the at least second media file;
generating a composite media file based at least in part on the information associated with the at least second media file; and
providing for display of the composite media file.

2. The method of claim 1, wherein receiving an indication of information associated with at least a first media file comprises receiving an indication of a number of media files to be used in generating the composite media file.

3. The method of claim 1, wherein receiving an indication of information associated with at least one media file comprises receiving an indication of information associated with at least one selected portion of the at least first media file.

4. The method of claim 3, wherein receiving an indication of information associated with at least one selected portion of the at least one media file comprises receiving an indication of information associated with a user contact.

5. The method of claim 3, wherein receiving an indication of information associated with at least one selected portion of the at least one media file comprises receiving an indication of coordinates associated with the at least one selected portion.

6. The method of claim 1, wherein generating a composite media file comprises modifying the at least second media file based on a predetermined set of criteria including at least one of user contact represented in the media file, position of a user contact in the media file, a geographic location of a user contact in the media file, or a temporal information associated with the at least first media file.

7. The method of claim 1, further comprising associating information to the at least one media file, wherein the information comprises information associated with a user contact.

8. The method of claim 1, wherein generating a composite media file comprises generating a composite image file.

9. The method of claim 1, further comprising communicating with a user contact based at least in part on receiving an indication of a selection of a user contact from the composite media file.

10. The method of claim 9, wherein communicating with a user contact comprises communicating via various communication methods comprising at least one of a telephone call, short message service (SMS) message, multimedia messaging service (MMS) message, e-mail, instant messaging, or other messaging protocol.

11. A computer program product comprising at least one computer-readable storage medium having computer-executable program code portions stored therein, the computer-executable program code instructions comprising:
first program code instructions for receiving an indication of information associated with at least a first media file;
second program code instructions for submitting a search request for information associated with at least a second media file based at least in part on the information associated with the at least first media file;
third program code instructions for receiving the information associated with the at least second media file;
fourth program code instructions for generating a composite media file based at least in part on the information associated with the at least second media file; and
fifth program code instructions for providing for display of the composite media file.

12. The computer program product of claim 11, wherein the first program code instructions for receiving an indication of information associated with at least a first media file include instructions for receiving an indication of a number of media files to be used in generating the composite media file.

13. The computer program product of claim 11, wherein the first program code instructions for receiving an indication of information associated with at least one media file include instructions for receiving an indication of information associated with at least one selected portion of the at least first media file.

14. The computer program product of claim 13, wherein the instructions for receiving an indication of information associated with at least one selected portion of the at least one media file include instructions for receiving an indication of information associated with a user contact.

15. The computer program product of claim 13, wherein the instructions for receiving an indication of information associated with at least one selected portion of the at least one media file include instructions for receiving an indication of coordinates associated with the at least one selected portion.

16. The computer program product of claim 11, wherein the fourth program code instructions for generating a composite media file include instructions for modifying the at least second media file based on a predetermined set of criteria including at least one of a user contact represented in the at least second media file, position of a user contact in the at least second media file, geographic location of a user contact in the at least second media file, or temporal information associated with the at least second media file.

17. The computer program product of claim 11, further comprising instructions for associating information to the at least one media file, wherein the information comprises information associated with a user contact.

18. The computer program product of claim 11, wherein the fourth program code instructions for generating a composite media file include instructions for generating a composite image file.

19. The computer program product of claim 11, further comprising instructions for communicating with a user contact based at least in part on receiving an indication of a selection of a user contact from the composite media file.

20. The computer program product of claim 9, wherein the instructions for communicating with a user contact includes instructions for communicating via various communication methods comprising at least one of a telephone call, short message service (SMS) message, multimedia messaging service (MMS) message, e-mail, instant messaging, or other messaging protocol.

21. An apparatus comprising a processor configured to:
receive an indication of information associated with at least a first media file;
submit a search request for information associated with at least a second media file based at least in part on the information associated with the at least first media file;
receive the information associated with the at least second media file;
generate a composite media file based at least in part on the information associated with the at least second media file; and
provide for display of the composite media file.

22. The apparatus of claim 21, wherein the processor configured to receive an indication of information associated with at least a first media file comprises the processor configured to receive an indication of a number of media files to be used in generating the composite media file.

23. The apparatus of claim 21, wherein the processor configured to receive an indication of information associated with at least one media file comprises the processor configured to receive an indication of information associated with at least one selected portion of the at least first media file.

24. The apparatus of claim 23, wherein the processor configured to receive an indication of information associated with at least one selected portion of the at least one media file comprises the processor configured to receive an indication of information associated with a user contact.

25. The apparatus of claim 23, wherein the processor configured to receive an indication of information associated with at least one selected portion of the at least one media file comprises the processor configured to receive an indication of coordinates associated with the at least one selected portion.

26. The apparatus of claim 21, wherein the processor configured to generate a composite media file comprises the processor configured to modify the at least second media file based on a predetermined set of criteria including at least one of user contact represented in the media file, position of a user contact in the media file, a geographic location of a user contact in the media file, or a temporal information associated with the at least first media file.

27. The apparatus of claim 21, further comprising the processor configured to associate information to the at least one media file, wherein the information comprises information associated with a user contact.

28. The apparatus of claim 21, wherein the processor configured to generate a composite media file comprises the processor configured to generate a composite image file.

29. The apparatus of claim 21, further comprising the processor configured to communicate with a user contact based at least in part on receiving an indication of a selection of a user contact from the composite media file.

30. The apparatus of claim 29, wherein the processor configured to communicate with a user contact comprises the processor configured to communicate via various communication methods comprising at least one of a telephone call, short message service (SMS) message, multimedia messaging service (MMS) message, e-mail, instant messaging, or other messaging protocol.

31. An apparatus comprising:
means for receiving an indication of information associated with at least a first media file;
means for submitting a search request for information associated with at least a second media file based at least in part on the information associated with the at least first media file;
means for receiving the information associated with the at least second media file;
means for generating a composite media file based at least in part on the information associated with the at least one additional media file; and
means for providing for display of the composite media file.
